(19) United States
(12) Patent Application Publication
(10) Pub. No.: US 2021/0081856 A1
(43) Pub. Date: Mar. 18, 2021

(54) Method and System for Generating Cleanliness Status and Location by Using Radio Frequency Identification to Track Linen Products Throughout Guest Rooms, Key Locations in Laundry Operations, and Exit Locations of Hotels.

(71) Applicant: Kelsy Marie Michely, Miromar Lakes, FL (US)

(72) Inventor: Kelsy Marie Michely, Miromar Lakes, FL (US)

(21) Appl. No.: 16/574,729

(22) Filed: Sep. 18, 2019

(51) Int. Cl. G06Q 10/06; G06Q 10/08; G06Q 50/12; G06Q 10/10; G06K 19/077; G06K 7/10; H04W 4/029

(52) U.S. Cl. CPC G06Q 10/0631; G06Q 10/087; G06Q 50/12; H04W 4/029; G06K 19/07758; G06K 7/10366; G06Q 10/107

(57) ABSTRACT

A method and system for generating a linen product's cleanliness status and location by using radio frequency identification to track linen products throughout guest rooms, key locations in laundry operations, and exit locations of hotels so as to provide guests a cleanliness status on linen products as well as to allow hotel management to monitor their linen product inventories. Check points' tracking controls communicate with identification tags of linen products throughout laundry operations and at exits to create various records useful to hotels and their guests, including a tracking record, a status record, a location record, and a lifecycle record.

### BACKGROUND OF THE INVENTION

### 1. Field of the Invention

The present invention relates to a tracking system. Specifically, the method and system of tracking linen products throughout guest rooms, key locations in laundry operations, and exit locations of hotels. The purpose of the method and system of tracking is to enhance the guest experience by using radio frequency identification to record information on when each linen product went through different key stages in laundry operations. Tracking linen products is ultimately intended for a mobile application service and webpage's utilization of the information generated to inform the guest on linen products' cleanliness. In addition, information generated may be utilized by hotel management to access information on linen products at different key stages in laundry operations and exiting the hotel to contribute to effective and efficient inventory management.

### 2. Background

The lodging industry in the United States of America includes leading global hotel brands, branded and independent properties, and bed and breakfasts, which are all referred to as hotels within the present invention. Statistics indicate there are over 50,000 hotels of various types and sizes accounting for 5,000,000 guests served each day, generating about $1,100,000,000 U.S. Dollars in U.S. sales per day (including hotel revenues, guest spending and taxes). Considering trends in growth rates for average daily rate, occupancy, supply and demand, the lodging industry is forecasted for continued growth. Accordingly, the number of hotels, guests hosted, and sales are increasing. With hotel growth comes the increase in quantities of linen products circulating hotels.

Linen products are categorized into bed linens and bath linens intended for daily use in guest rooms, and specific items within these categories include linen products such as pillow cases, sheets, duvet covers, blankets, bath towels, bath mats, hand towels, wash cloths, and bath robes. Linen products may be “soiled” when contaminated with bloodily substances (e.g. blood), bodily tissues and fluids, and external contaminants such as residues and allergens. To tackle laundering these linen products to achieve hygienically “clean” status, some hotels utilize on-site laundry operations, while some hotels outsource their laundry operations, and other hotels utilize a system of both on-site and outsourced laundry operations. Without effectively tracking linen products throughout laundry operations, hotels face implications from soiled linens and inaccurate inventory insights. Various solutions attempt to address these problems, but they fall short. In the presence of today's competition, hotels depend on creating an exceptional experience to gain competitive advantage in the hospitality industry.

To create an enjoyable and safe experience for guests, hotels intend for their linen products to be laundered daily, or at a minimum between guests, but often times, linen products are not clean for the next guest. Soiled linens spread illness-causing bacteria, traces of drugs or other deadly substances, as well as food and animal allergens. Soiled linens ultimately cause customer dissatisfaction, putting guests at risk and increasing hotel liabilities.

Exposure to bacteria, certain residues and allergens from unchanged linen products puts guests at risk. Studies targeting bed bacteria show that unwashed linens start cultivating bacteria from first being washed and can build up to having more quantities of bacteria present than on toilet seats, handles and door knobs. Implications from bacteria found on soiled sheets include pneumonia, bloodstream infections, antibiotic resistance, and infections similar to food poisoning. Additionally, residue from drugs and tobacco smoke may dwell on unchanged linens. Particulates cling to surfaces in the room, and gases may be absorbed by linen products, which can then re-emit as compounds into the air, creating carcinogens that may then be inhaled, absorbed or ingested. Nicotine is an example of a residue that may be on a guest's clothes and contracts to the linens, and it stays on said linens until properly washed. Inhaling, absorbing, or ingesting these compounds creates an event of third hand smoke (THS) exposure, causing allergies such as sneezing, watery eyes, stuffy nose, and more. THS exposure is especially dangerous to small children in that they often put their hands in their mouths and will ingest the tobacco residue if they had touched contaminated surfaces. Residue can be washed off of linens, but if these linen products are not changed between guests, the residue will be present for the next user and puts them at risk of exposure. Similar to residues, allergens may linger on linens until washed. Food allergies are very common in the Unites States population. If a guest was eating peanuts, for example, on the bed and the next guest with an allergy to peanuts comes into contact with the allergen, they will experience an allergic reaction including hives, swelling, diarrhea and even cardiac arrest. Similar to food allergies are allergies to animals, and guest rooms with dander lingering on unchanged linens after an animal was present may prove hazardous to the next guest. If the next guest is vulnerable to these allergies and is exposed to the allergen, they will experience an allergic reaction including sneezing, itchy, red or watery eyes, swelling, and difficulty breathing. Allergic reactions vary depending on one's vulnerability, but all it takes is one severe reaction to negate a brand's reputation. Overall, there are numerous risks that surface when guests are exposed to linens soiled from the previous guest. Although hotels put up their best efforts to provide clean linen products, the repercussions from soiled linen products are threatening.

Housekeeping employees are tasked to change linen products according to protocol; however, management lacks proper records to ensure rooms are serviced. Efficient employees perform in the best possible manner without wasting time, and effective employees accomplish a purpose producing a result. Considering this, hotels lack a method to record employees' efficiency and effectivity at changing linen products. Oftentimes in hotels, not all soiled linens products in a room are replaced with clean ones, and sometimes not at all. Even if the bed sheets are replaced but the pillowcases are not, the risk of spreading bacteria, residues, or allergens is still prevalent with contact of the contaminated pillowcase to the freshly cleaned bed sheet. Contamination defeats the purpose of changing part of a bed or bath linen set and reduces effectivity. All businesses strive for productivity via efficient and effective employees, but there is no way to verify clean linen products are actually provided from employees.

Management based off of inaccurate inventory insights is a concern, contributing to high buffering costs, premature termination, and theft. Ambiguity in arriving clean stock (par levels) from laundry operations results in high buffering costs because it is difficult to anticipate linen products coming from laundry operations and to plan for a prime process. For hotels, the optimal par stock number is 3, meaning 3 sets of each linen product per room. However, many locations increase their capital expenditure on linen products in the process of purchasing additional stock when trying to address the ambiguity in arriving clean stock. Problems in par levels are associated with inaccurate lifecycle information, so some linen products are terminated when management assumes they have reached end-of-life. In addition to unnecessary spending to improve linen stock and premature termination, theft by guests and staff is problematic. Many guests will steal linen products, transporting them through exits, reducing a hotel's linen inventories. It is estimated that hotels and resorts lose up to 15-20% of their linen inventory due to termination or premature loss (theft). Unnecessary spending to improve linen stock, inaccurate lifecycle information causing premature termination, and theft are all factors contributing to inaccurate inventory insights, creating a difficult situation for managers to manage when they do not have enough information to base their decisions off of

Some attempted solutions have addressed these cleanliness and inventory problems, but still have come short. One attempted solution includes using post-it notes implying a room cleaning, however there is no record of linen products actually replaced, or when the note was placed. The note could be present for the duration of multiple guest stays, or just placed without the linen products actually replaced. Another attempted solution includes employees reporting to management when linen products are missing and having sensors at exits to sound alarms similar to shoplifting. Although a solid effort, ambiguity was still associated with source and point of theft, and the alarm sound was not favored by guests. Attempted solutions have addressed room cleanings, inventory and theft; however, problems are still prevalent because none have proved to be valid. With today's expansive competition, hotels depend on enhancing the guest's experience to gain the competitive advantage. Guests constantly worry about the cleanliness of their linen products and management is searching for new methods to increase their bottom line.

There are many disadvantages to existing linen management techniques, including: the inability for guests to know the cleanliness status of their linen products which causes customer dissatisfaction, risk of contracting bacteria or exposure to harmful residues or allergens from unlaundered linens, inability to record linen replacements by housekeeping, uncertainty in projecting par levels, premature termination, pinpointing theft, and unnecessary increase in capital expenditure spent replacing linen products.

In other words, the existing linen product management has the following drawbacks.
1. No way to prove linen product cleanliness to guests.
2. No way to reduce liability of guests risking exposure to harmful bacteria, residues, or allergens.
3. No way to effectively track linen products as they circulate the laundry operations system.
4. No way to generate detailed records on linen product replacements by housekeeping.
5. No way to locate linen products in real time or near real time at hotels.
6. No way to project and anticipate linen stock throughout laundry operations.
7. No way to reduce premature termination.
8. No way to pinpoint theft.
9. No way to effectively decrease shrinkage created by premature termination and theft.

### BRIEF SUMMARY OF THE INVENTION

In view of the foregoing disadvantages inherent in the known types of laundry operations systems and inventory management, the present invention provides a method and system for generating a linen product's cleanliness status and location by using radio frequency identification to track linen products throughout guest rooms, key locations in laundry operations, and exit locations of hotels.

The general purpose of the present invention, which will be described subsequently in greater detail, is to provide a new method and system to generate a linen product's cleanliness status and location of linen products in guest rooms, key locations in laundry operations and exit locations of hotels through enabling use of radio frequency identification (RFID), which is not anticipated, rendered obvious, suggested, or even implied by any attempted solutions, either alone or in any combination thereof.

To attain this, the present invention generally comprises certain RFID technologies such as one or more identification tags comprised of a microchip and protective sleeve, one or more readers utilizing an internal antenna emitting radio frequency waves, or an antenna connected via cable emitting radio frequency waves, one or more tracking databases with data management capabilities, a data storage platform such as the Cloud, a data transmission source such as Wi-Fi internet connection, a plurality of check points in guest rooms, a plurality of check points throughout on-site laundry operations, or a plurality of check points throughout outsourced laundry operations, or a plurality of check points throughout on-site and outsourced laundry operations, or a plurality of check points throughout exit locations, any of which are utilized to generate a linen product's cleanliness status and location, in addition to creating records including location record, status record, time stamp record, notifications, birth record, data record, lifecycle record, tag commissioning, and file management.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary objective of the present invention is that the tracking system is adapted to monitor linen products in near real time as they travel throughout a hotel's guest rooms and key locations in laundry operations, generating a status record based on information gathered and records generated at each of the check points at key locations, so as to provide guests a cleanliness status on linen products associated with their room number, and an overall report on laundry operations.

A second objective of the present invention is that the tracking system will generate location records for each linen product so as to allow management to monitor inventories by viewing categorical quantities at each key location, tracking movement, locating linen products, and more.

A further objective of the present invention is that it is intended to benefit settings in which linen products are laundered daily for users, such as hotels.

Another objective of the present invention is to provide a method and system for tracking linen products, wherein Radio Frequency Identification (RFID) technology is the preferred solution that addresses this concern. The present invention will provide tracking and monitoring of linen products to enhance the quality of guest services, increase efficiency and productivity of laundry operations, lower hotel's liability and increase hotel's profit.

A further objective of the present invention is that the system will utilize RAIN RFID technology, which comprises an Ultra High Frequency (UHF) RFID (Fixed/Handheld) Reader operating in the US standard frequency range of 902-928 MHz. The UHF RFID reader is connected to Wi-Fi Internet, so it can instantly update the Cloud-based tracking control with information on linen product movement, allowing records to be utilized from any location by authorized users.

Another objective of the present invention is that the system does not store or collect personal information. The only information available through the system is record information on each linen product.

A further objective of the present invention is that it will be able to abide by air-interface protocol standards ratified by the International Organization for Standardization (ISO), and is fully FCC Compliant.

Another objective of the present invention is that the tracking system comprises of a cloud-based database, i.e. tracking control, linked with a plurality of check points in key locations throughout guest rooms, laundry operations and exit locations, wherein a check point is comprised of a RFID Fixed Reader and a RFID Antenna connected via cable, or a RFID Handheld Reader. A plurality of identification tags are permanently affixed on the linen products, such that when these linen products are moved to a check point's read field, the corresponding identification tags are registered, and information generated by the reader is instantaneously sent to the Cloud via Wi-Fi Internet Connection. Therefore, the tracking control is able to monitor linen products by reading them so as to generate detailed records that benefit hotel guests and management.

A further objective of the present invention is to provide installation guides for fixed and mobile check points, in addition to the necessary databases for the RFID readers at each check point, so as to equip the hotel to generate accurate information on their linen products.

Another objective of the present invention is that the method utilizes a RFID Handheld Reader for delivery during room cleaning by housekeeping and guest-requested linen product delivery. The RFID Handheld Reader may also be utilized so as to identify any linen product's identification number to search detailed records stored in the Cloud.

A further objective of the present invention is to provide check point suggestions for on-site laundry operations, outsourced laundry operations, on-site and outsourced laundry operations, and exit locations, so as to generate detailed records, however number of check points and locations may vary according to hotel or resort, so long as the check points are throughout laundry operations and exit locations. Suggested check points for on-site laundry operations include: linen sorting area, washing machines, drying machines, linen storage, and guest room. Suggested check points for outsourced laundry operations include: linen sorting area, outgoing linens, incoming linens, linen storage, and guest room. Suggested check points for on-site and outsourced laundry operations include: linen sorting area, outgoing linens, incoming linens, washing machines, drying machines, linen storage, and guest room. Suggested check points for exit locations include: staff exit, front exit, rear exit, side exit #1, and side exit #2.

Another objective of the present invention is that the check points may be located at other locations within laundry operations so long as to generate information on linen products' cleanliness and inventory insights. The present invention allows key locations to be flexible so long as they are throughout laundry operations as it is focused on tracking linen products throughout laundry operations. This same flexibility is also applicable to exit locations so long as hotels are able to track linen products moving offsite.

A further objective of the present invention is the use of database software installed within the reader to send specific information to the Cloud, including but not limited to: notifications, location, status, timestamp, work-in-process tracking, inventory control, lifecycle, and current data record. Within the tracking control, there is also the option for tag commissioning, file management, and other data management functions. Incorporating the reader with database software creates a powerful tracking control system that has the information necessary to disclose the cleanliness status of linen products according to the most recent circulation throughout laundry operations and the timestamps recorded at each check point. Additionally, incorporating the reader with database software gives hotel management detailed records on linen products generating inventory insights.

Another objective of the present invention is to record the date and time that each linen product enters the reader field of any of the check point locations to create a genuine timestamp reflective of movement throughout laundry operations and/or exit locations.

A further objective of the present invention is that the tracking system will generate records for each linen product including category, timestamp at check point, “CLEAN” or “SOILED” status according to check point, and further data records contributing to history. Additionally, records generated will include information on quantity of linen product categories at each check point, and overall quantities for “CLEAN” or “SOILED” statuses to further improve inventory insights focused on cleanliness status and location.

Another objective of the present invention is to provide decision trees utilizing specific rules to generate cleanliness statuses for each linen product.

A further objective of the present invention is that the tracking control is able to record which linen products were replaced in each guest room when registered with the RFID Handheld Reader, so as to allow management to monitor staff productivity and efficiency.

Another objective of the present invention is that the tracking system allows management to effectively track linen products as they circulate the laundry operations system.

A further objective of the present invention is that the tracking system is adaptable to utilize RFID tags that are sensitive to environmental changes, for example tags that sense when the linen product is exposed water, temperatures, pressure, etc., so as to indicate cleanliness status.

Another objective of the present invention is that the tracking system provides information on inactive identification tags for linen products that may be lost in the hotel or resort so as to use a handheld reader to search for the linen product.

A further objective of the present invention is that the tracking control's records of linen products' wash counts presents management with the ability to monitor lifecycle and items nearing end-of-life termination, rather than assuming wash count and carrying out premature termination. Terminated linen products can be recorded with information such as the category and reason for termination. Goal lifecycle wash count for each category may be compared with the actual average lifecycle.

Another objective of the present invention is that the system generates and sends notifications to preset management contacts in the form of an email and popup notification on computer. Subject matter of notifications includes status changes such as to “OFFSITE” or “TERMINATED,” lifecycle end, inactive identification tags, and daily, weekly, monthly, and/or annual reports. Notifications ensure insights to linen utilization so as to improve the guest's experience.

A further objective of the present invention is that the tracking control's records of linen products location within the laundry operations system provides accurate inventory insights for management, further providing them the ability to anticipate linen stock throughout laundry operations, anticipate end-of-life termination, and pinpoint theft.

Another objective of the present invention is that the tracking system provides management a way to pinpoint theft by analyzing recent check point records. Properties opting to install check points at exit locations may do so in addition to the core method and system of tracking linen products throughout laundry operations. Exit check points may include various staff exits and various public exits. The tracking control will simply record which check point the linen product passed while exiting, in addition to identification number and timestamp. Upon record generation, the tracking control will send a notification to predetermined management contacts including the record and last detected check point, i.e. point of exit. This information may be utilized at management's discretion to monitor surveillance footage at the location and time of occurrence so as to determine who stole the item(s). Hotel management may do as they wish with this information.

A further objective of the present invention is that the tracking system allows management to effectively identify linen products that exit the building in theft occurrences and see which category of linen products in laundry operations their inventories are low on.
Hotels have many benefits:
1. Ability to track linen products throughout laundry operations and exit locations.
2. Real-time inventory insights.
3. Cloud-based records.
4. Time reduction with smart inventory.
5. Digitized laundry operations.
6. Housekeeping management.
7. Compare goal lifecycles with actual average lifecycles.
8. Decrease in shrinkage.
9. Reduced liability because of detailed records.
10. Improve customer safety by decreasing health risks.
11. Customer satisfaction and brand loyalty.
Hotel Guests have many benefits:
1. Reduced likelihood of using soiled linen products.
2. Reduced likelihood of contracting an illness from using soiled linen products.
3. Ability to check cleanliness status of linen products associated with room number.
4. Ability to check details on laundry operations.
5. Assurance their hotel is concerned with creating a luxurious, enjoyable experience for the duration of their stay.

### BRIEF DESCRIPTION OF THE DRAWING(S)

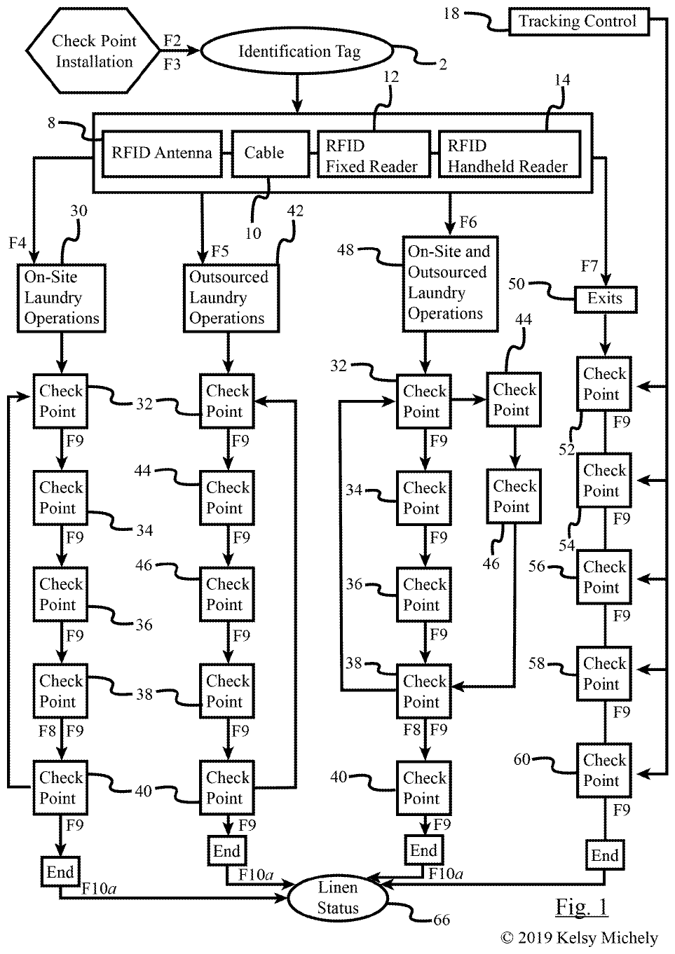

Description of FIG. 1: Flow diagram of overall method including on-site laundry operations processes, outsourced laundry operations processes, on-site and outsourced laundry operations processes, exit locations, and additional figure references within for more detailed flows in accordance with the present invention.

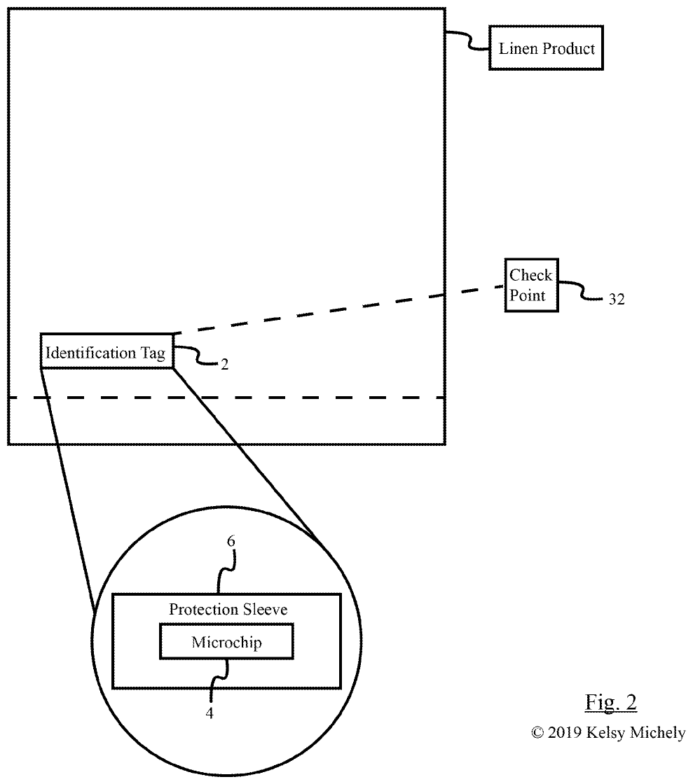

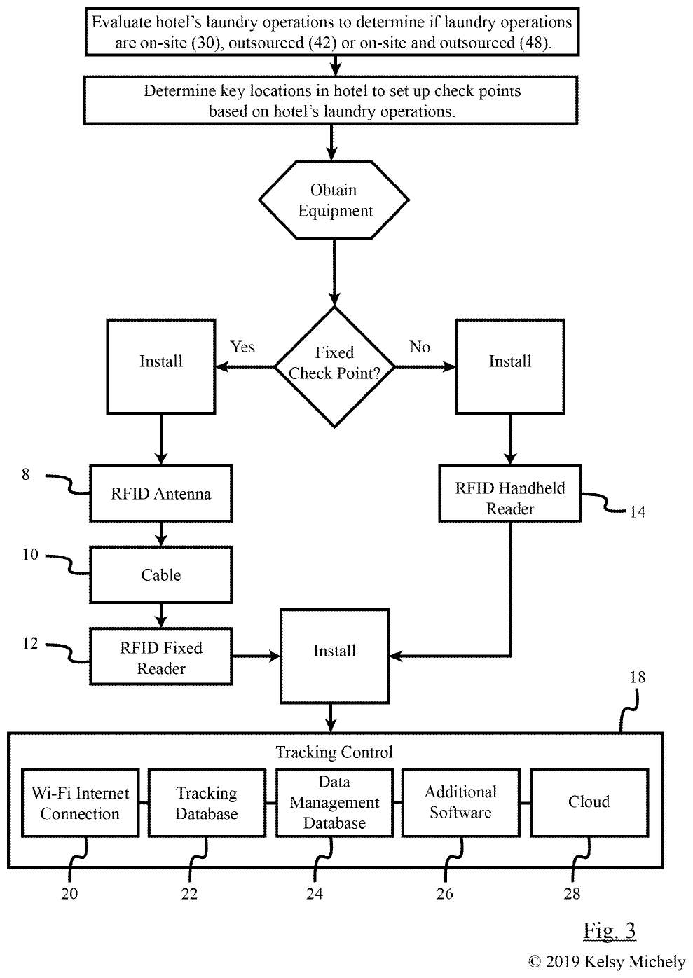

Description of FIG. 2: Schematic view to show the structure of the identification tag permanently affixed to linen product in accordance with the present invention.

Description of FIG. 3: Flow diagram of check point installation including necessary equipment and software in accordance with the present invention.

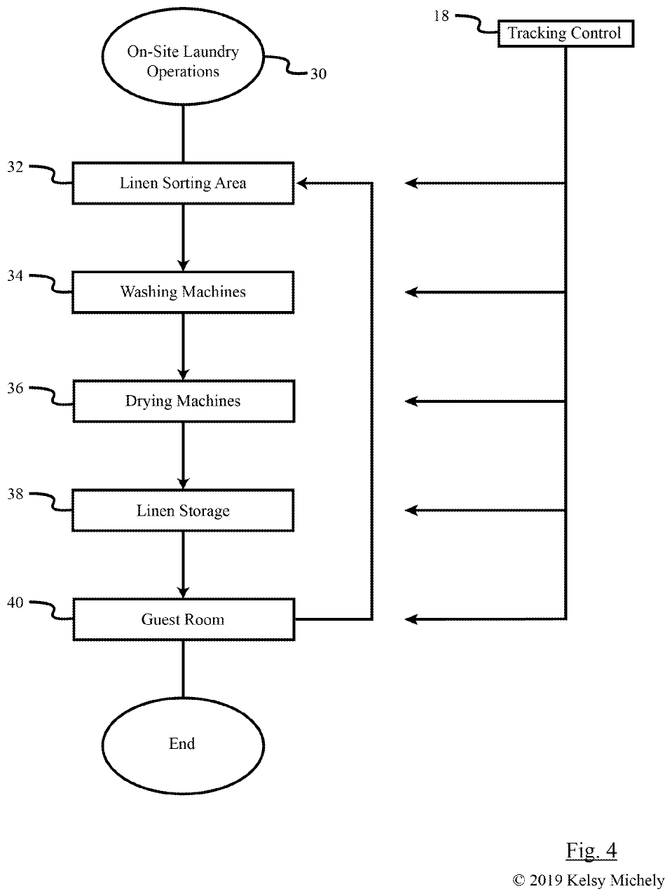

Description of FIG. 4: Flow diagram of check points in on-site laundry operations in accordance with the present invention.

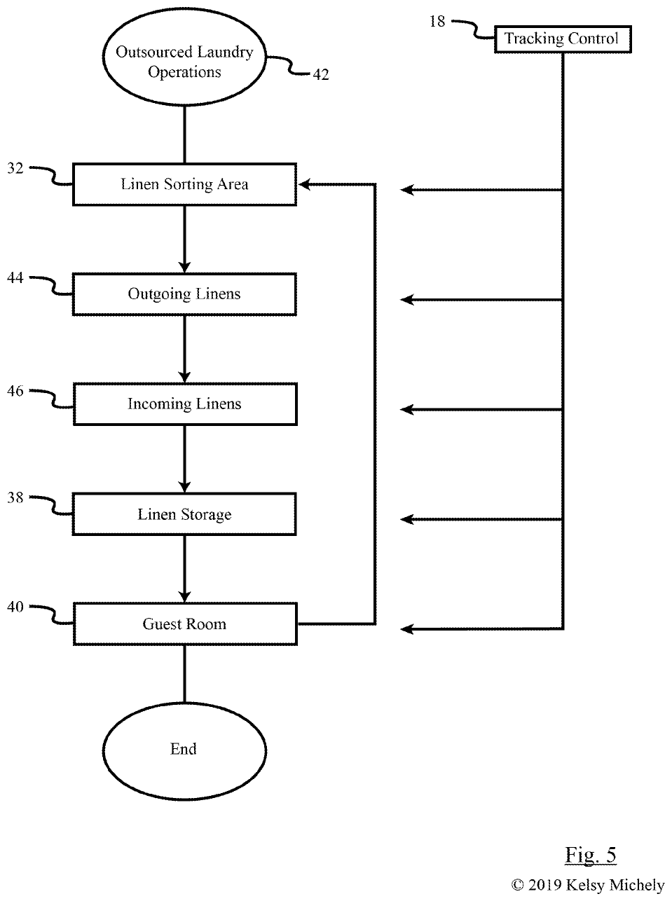

Description of FIG. 5: Flow diagram of check points in outsourced laundry operations in accordance with the present invention.

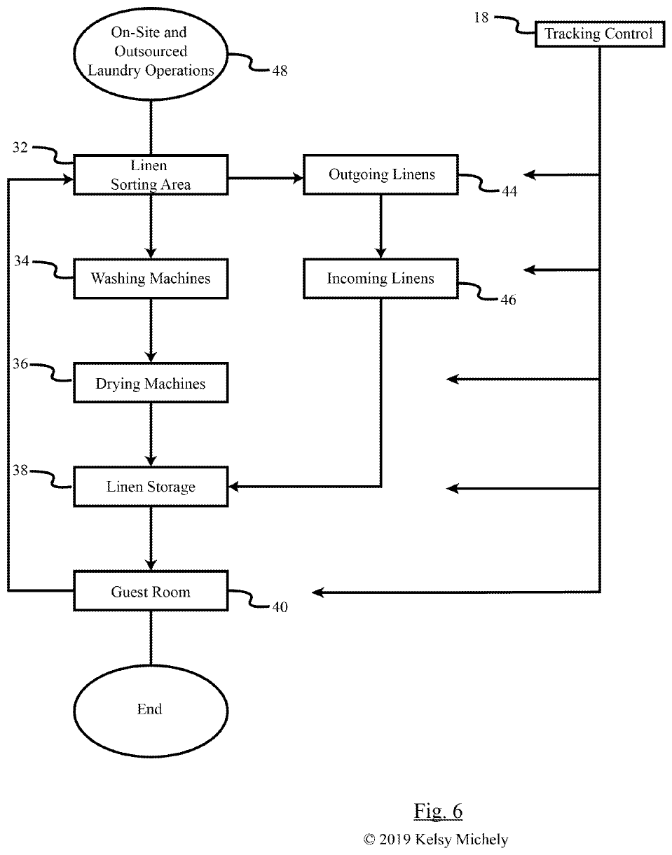

Description of FIG. 6: Flow diagram of check points in on-site and outsourced laundry operations in accordance with the present invention.

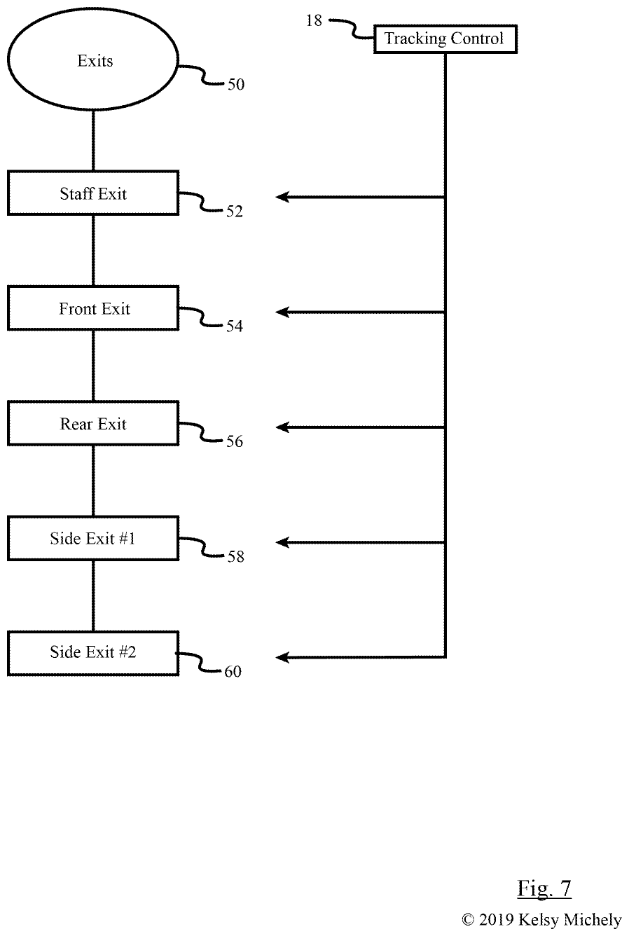

Description of FIG. 7: Block diagram of check points in exit locations in accordance with the present invention.

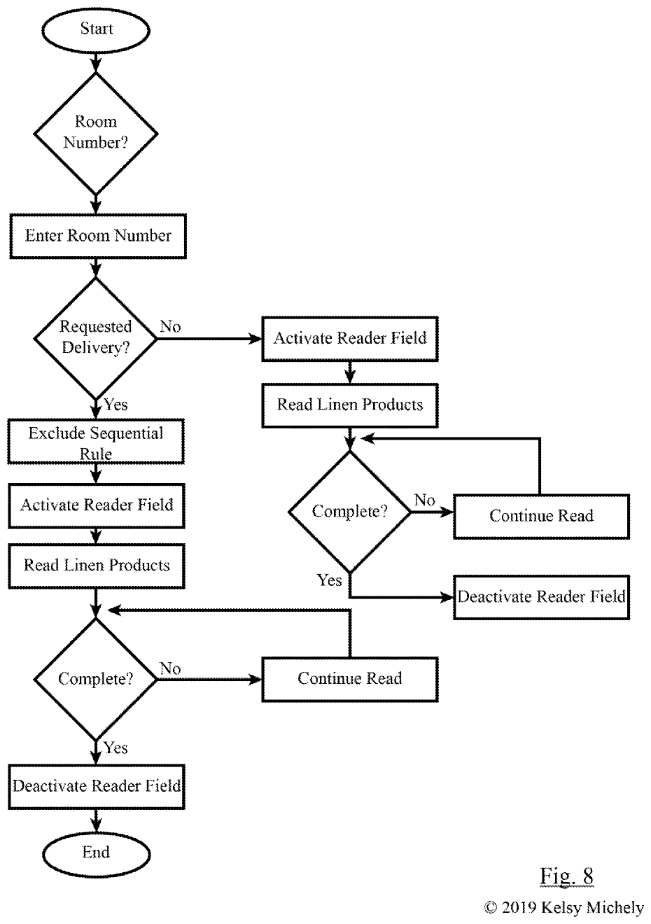

Description of FIG. 8: Decision tree for linen product delivery in accordance with the present invention.

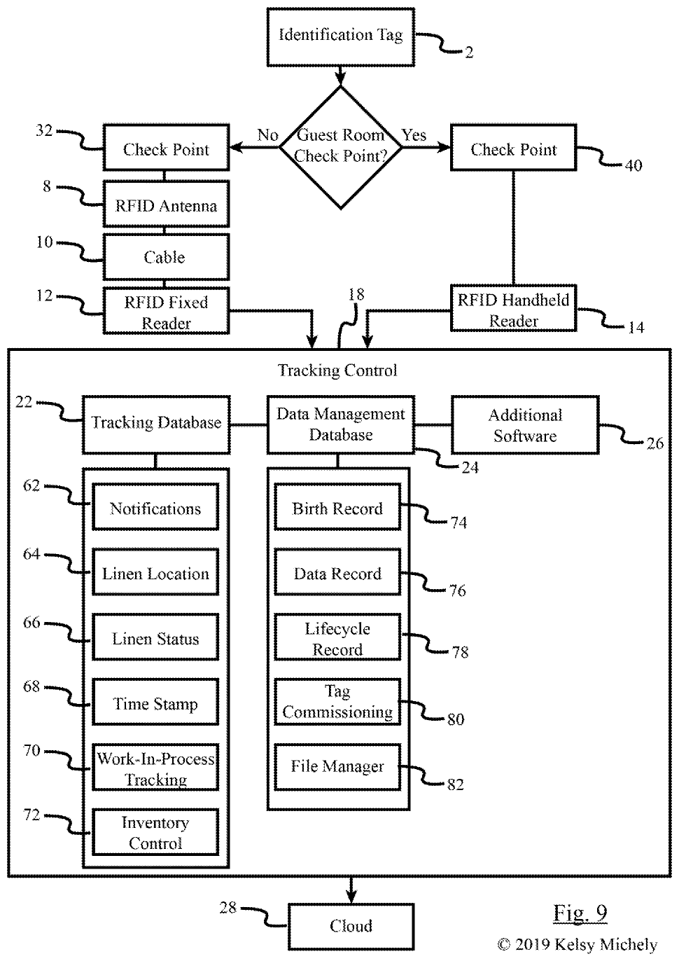

Description of FIG. 9: Flow diagram of the tracking method and system in accordance with the present invention.

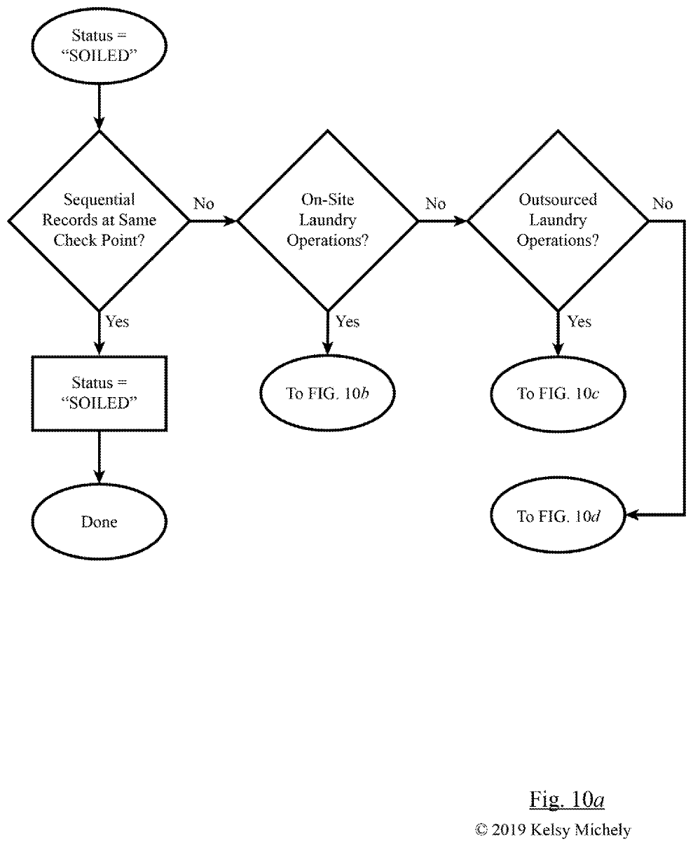

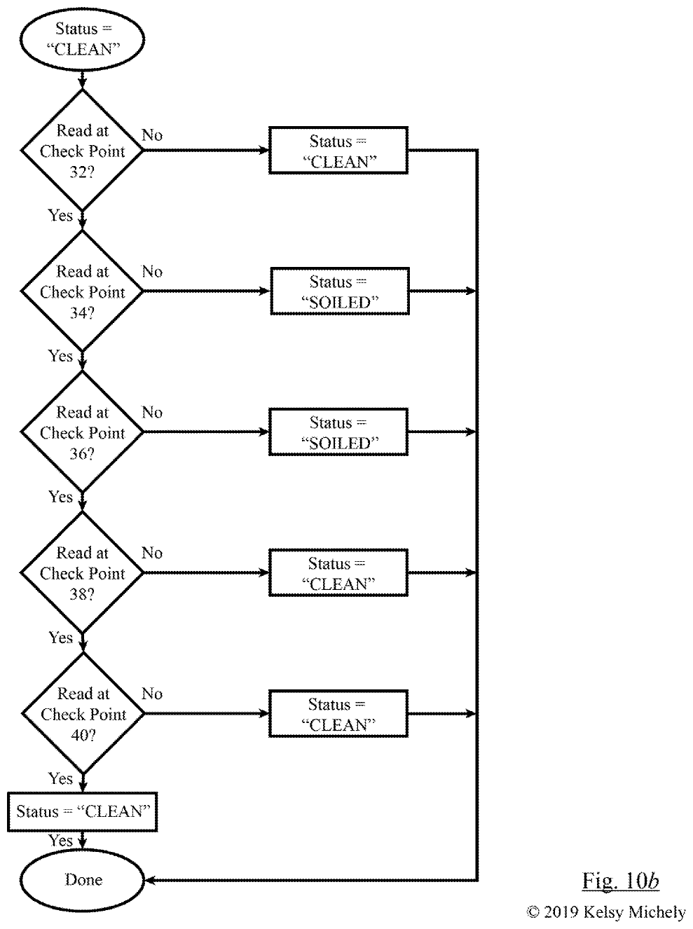

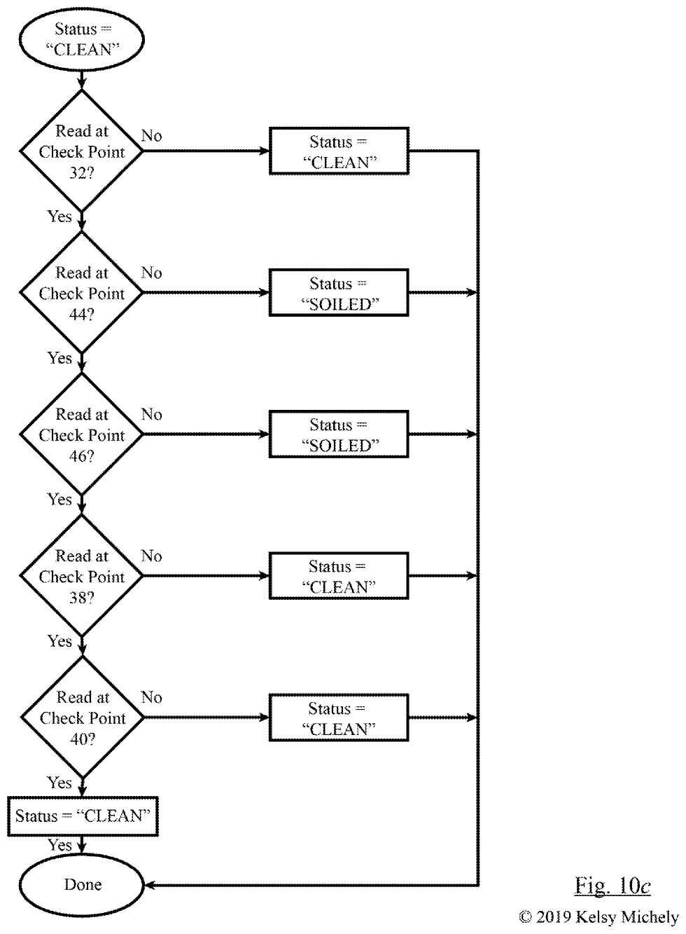

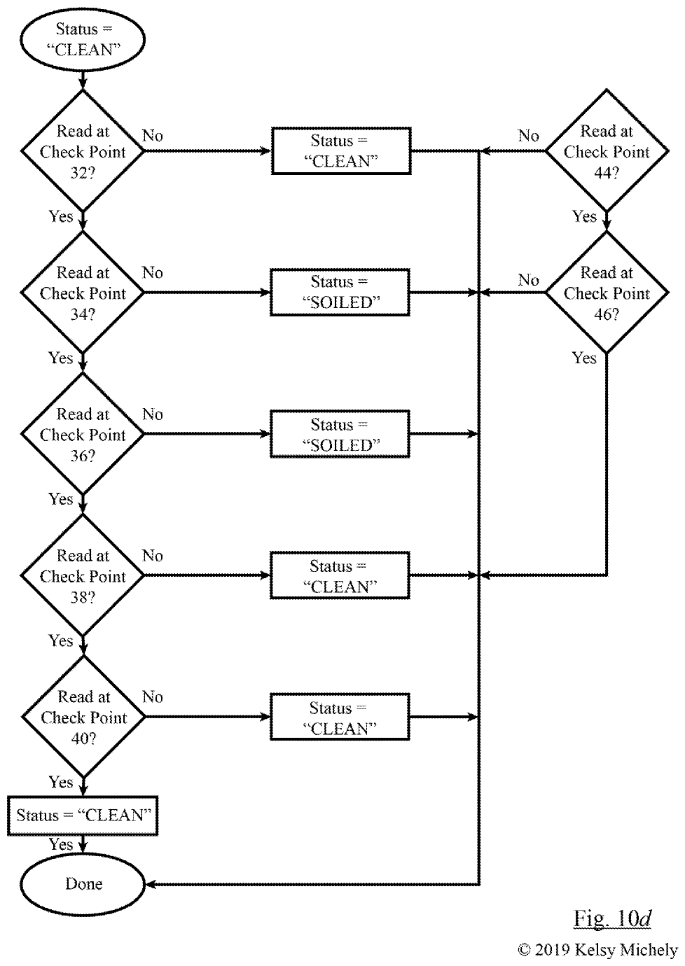

Description of FIG. 10a: Decision tree for cleanliness status of “SOILED” in accordance with the present invention.

Description of FIG. 10b: Decision tree for cleanliness status of “CLEAN” for linen products from on-site laundry operations in accordance with the present invention.

Description of FIG. 10c: Decision tree for cleanliness status of “CLEAN” for linen products from outsourced laundry operations in accordance with the present invention.

Description of FIG. 10d: Decision tree for cleanliness status of “CLEAN” for linen products from on-site and outsourced laundry operations in accordance with the present invention.

### DETAILED DESCRIPTION OF THE INVENTION

The following is a detailed description of embodiments of the invention depicted in the accompanying figures. The embodiments are in such detail as to clearly communicate the invention. However, the amount of detail offered is not intended to limit the anticipated variations of embodiments; but, on the contrary, the invention is to cover all modifications, equivalents, and alternatives falling within the spirit and scope of the present invention. The detailed descriptions below are designed to make such embodiments obvious to a person of ordinary skill in the art.

Generally speaking, methods and systems to generate cleanliness status and location by tracking linen products throughout guest rooms, key locations in laundry operations, and exit locations of hotels using radio frequency identification (RFID) are disclosed. Methods of reading and analyzing information from RFID tags and determining cleanliness status and location according to the determined conditions are discussed. Embodiments comprise leading global hotel brands, branded and independent properties, and bed and breakfasts, which are all referred to as hotels. Embodiments further comprise hotels utilizing one or more RFID systems to read information from a number of RFID tags to generate cleanliness status and location. In some embodiments, cleanliness status may be more important than location status, wherein cleanliness status may be used for purposes including providing guests cleanliness status information for linen products, generating inventory records, utilizing records to increase effectivity and efficiency, and digitizing laundry operations. Other embodiments may contradict the aforementioned embodiment, thus placing a higher value and focus on location status for records contributing to inventory management, shrinkage reduction, deliveries, lifecycle, notifications, linen product identification, and tracking.

While portions of the following detailed discussion describe many embodiments employing RFID methods and systems to generate cleanliness status and location of hotel linen products, upon review of the teachings herein, a person of ordinary skill in the art will recognize that the following invention may be practiced in a variety of ways, such as by a complete hardware system at all guest rooms, key locations in laundry operations, and exit locations, or by using software to generate additional information based on tracking records from various check points. Further, while embodiments discuss generating cleanliness status and location of hotel linen products, one of ordinary skill in the art will recognize that other businesses desiring this level of linen product tracking may also deploy these methods and systems in similar business settings to perform substantially equivalent functions.

RFID technologies may offer promise in helping hotels efficiently manage linen products for guests. To better understand how RFID data may be captured and analyzed, and how such data may be used to appeal to hotel managers and guests, one needs to understand how this technology works.

RFID technology uses radio waves to identify objects. In a simple form of an RFID system, said RFID system may comprise two components, a RFID tag and a RFID reader. RFID tags, alternatively referred to as identification tags, exist in many specifications. RFID tags may be in the form of labels, wet or dry inlays, laundry tags, vehicle tags, cards, sensors, and many other forms suitable for varying environments and applications. Generally, they contain one or more coils to serve as an antenna, and a radio transceiver contained on a silicon microchip. The microchip may store information, such as a unique identification number to identify the object to which the tag is attached. Some RFID tags may allow a reader to update or change the information stored in the tag. Additionally, RFID tags may be classified as passive or active. Passive tags typically do not broadcast any information stored within the tag until activated by a RFID reader. Active tags may constantly broadcast identification numbers or information stored on the microchip. Active tags typically contain batteries which may provide additional power for transmitting information.

RFID readers may have the same basic components as RFID tags, including antenna and reader electronics. The reader generally performs several functions. The reader antenna may produce low frequency (LF) magnetic fields, high frequency (HF) magnetic fields, or ultra-high frequency (UHF) magnetic fields. The magnetic field may activate RFID tags within the vicinity of the reader, or read field, to activate the exchange of information. The magnetic field may also provide the actual operating power for passive RFID tags to power the microchip and transmit information. The reader receives information transmitted from the tag, then stores it or transmits it to another device, such as a computer, for processing.

1. Overview

Turning now descriptively to the drawings, in which similar reference characters denote similar elements throughout the several views, FIGS. 1 through 10d illustrate the preferred embodiment for a method and system for generating cleanliness status and location of linen products by using RFID technology to track linen products as identified by identification tag 2 throughout guest rooms 40, on-site laundry operations 30, outsourced laundry operations 42, on-site and outsourced laundry operations 48, and exits 50. The identification tag 2, is comprised of a RFID microchip 4 within a protection sleeve 6, which is registered via radio frequency waves. At a fixed check point, a RFID antenna 8, reads the radio frequency waves and sends data via cable 10 to a RFID Fixed Reader 12. At a mobile check point, a RFID Handheld Reader 14 reads the identification tag 2. Information processed by the RFID Fixed Reader 12 and the RFID Handheld Reader 14 may be instantaneously sent to the Cloud 28 via Wi-Fi Internet Connection 20. The system of the present invention will leverage the hotel's existing Wi-Fi Internet Connection 20 to communicate rather than any corporate network. The method is further comprised of a directional flow of linen products throughout key locations in on-site laundry operations 30 comprising check points 32, 34, 36, 38, and 40. Furthermore, the method is comprised of a directional flow of linen products throughout key locations in outsourced laundry operations 42 comprising check points in order of 32, 44, 46, 38, and 40. The method is also comprised of a directional flow of linen products throughout key locations in on-site and outsourced laundry operations 48 comprising check points 32, 44, 46, 34, 36, 38, and 40. Additionally, the method is further comprised of exit check points 50 at the staff exit, front exit, rear exit, side exit #1 and side exit #2, as respectively identified by check points 52, 54, 56, 58, and 60. Identification tags 2 recorded at any of the aforementioned check points will be recorded in the tracking database 22, data management database 24 and additional software 26, wherein resides notifications 62, linen location 64, linen status 66, time stamp 68, work-in-process tracking 70, inventory control 72, RFID tag commissioning 80, RFID file management 82, birth record 74, current data record 76, and lifecycle record 78. Information generated with use of the tracking database 22, data management database 24, and additional software 26 contributes to the on-site laundry operations record 30, the outsourced laundry operations record 42, or the on-site and outsourced laundry operations record 48, and the data is necessary to achieve the objective of generating cleanliness status and location.

The system is fully FCC compliant. The architecture of the system is intended to have UHF RFID antennas operating at the United States standard frequency of 902-928 MHz, although other frequencies may be used in other countries consistent with the spirit of the invention, or if the United States standards of frequency change. These antennas will be listening to RFID microchips at the check points within the hotel, creating a passive RFID system, to allow the system to compile information of the linen products for management to review and for status information to be provided to guests. The system works within a self-contained network. A description of the present invention and the preferred embodiment is further detailed in the following sections fragmented to highlight various key features sequential to FIGS. 1 through 10d.

2. Identification Tags

The preferred embodiment includes a passive Ultra High Frequency (UHF) RFID microchip 4, however other RFID microchip technologies may be used consistent with the spirit of the invention. FIG. 2 depicts a schematic view of the identification tags 2 comprised of a RFID microchip 4 and a protection sleeve 6 adapted to wirelessly communicate with fixed check points including a RFID Antenna 8 and RFID Fixed Reader 12, and mobile check points including a RFID Handheld Reader 14. Generally, the identification tag 2 is a RFID tag intended for use in laundry settings. Specifically, the identification tag 2 includes protection sleeve 6 comprised of material that is water proof, heat resistant, chemical resistant, able to withstand harsh laundry environments, and is sealed to protect the RFID microchip 4 therein. The identification tag 2 is permanently affixed to each of the linen products so as to identify each linen product. Identification tags may be affixed via sewing, heat-sealing, or pouch, therefore the preferred method is creating a pouch and using a sewing machine to sew around the pouch so as to permanently affix and further protect the protection sleeve 6, however other affixation techniques may be used consistent with the spirit of the invention, for example, the identification tag 2 may be embedded into the seam of the linen product. As numerous linen manufacturers are beginning to sell linen products with identification tags 2 already permanently affixed, those linen products are also consistent with the spirit of this invention. Nonetheless, an identification tag 2 which is of passive UHF RFID technology must be permanently affixed to each linen product. Because UHF RFID technology is orientation-insensitive, positioning identification tag 2 may be in any orientation.

According to current technology, the average identification tag 2 with a passive UHF RFID microchip 4 has an estimated lifetime of 200 wash counts, whereas the average linen product lifetime in hotels is under 200 wash counts. It is concluded that a linen product's identification tag 2 will not have to be replaced, unless there is unforeseen failure attributed to normal use such as distortion. Furthermore, this method does not call for reuse of identification tags 2 when a linen product reaches end-of-life termination; however, as environmental resistance of identification tags 2 improves over time with evolving technology, reuse may be applicable consistent with the spirit of the invention. In addition to reuse of identification tags 2, when a linen product is terminated under 100 wash counts, or a predetermined quantity so as not to exceed average lifecycle when added to a new linen product's average lifecycle, the identification tag 2 may be removed and permanently affixed to another linen product so long as a new identification number is granted to ensure new records are generated reflecting the new linen product.

3. Check Point

The present invention values high read rates respective to the high quantities of linen products that circulate laundry operations. With this, the preferred embodiment incorporates passive UHF RFID technology in the check points, wherein frequencies range from 902-928 MHz. Passive UHF RFID systems have read fields that are limited by the power of the tag's backscatter, i.e. radio signal reflected from the tag to the reader, so the read fields are typically less than 30 feet. To create the desired read field, one must consider the equipment used, bearing in mind read fields vary depending on manufacturing of equipment used. The user of this method must consider if the equipment's placement for one check point might create a read field that overlaps with the read field of another check point and adjust accordingly modifying placement of the check point's equipment to avoid read field overlap or eliminating a check point due to space constraints. Other RFID technology such as High Frequency RFID (13.56 MHz) may be used consistent with the spirit of the invention; however, UHF RFID technology is favored because of its advanced capabilities in reading large quantities of identification tags 2.

FIG. 3 depicts a flow diagram for check point installation. Evaluation of the hotel's laundry operations is necessary to determine key locations in the hotel to set up check points. For fixed check points, a RFID Antenna 8 and RFID Fixed Reader 12 are mounted on a stationary point in the desired read field and connected via cable 10. For mobile check points, a RFID Handheld Reader 14 is used to read and record identification tags 2. Both the RFID Fixed Reader 12 and the RFID Handheld Reader 14 are installed according to specific manufacturer directions, including establishing Wi-Fi Internet Connection 20 and software installed including the tracking database 22, data management database 24, and any additional software 26. As identification tag 2 enters the read field of RFID Antenna 8 or is recognized when RFID Handheld Reader 14 activates the read field, the identification tag's 2 internal antenna uses energy from the radio frequency waves to send its own signal back. Once the identification tag 2 is detected, information is processed by the RFID Fixed Reader 12 or the RFID Handheld Reader 14, and then instantaneously sent on to the Cloud 28 via Wi-Fi Internet Connection 20. Check points may vary as RFID technology evolves, however installation to achieve this method of tracking is still within the scope of the present invention.

4. On-Site Laundry Operations

FIG. 4 depicts a flow diagram of linen products throughout on-site laundry operations 30. Due to potential read field overlap or variance in desired check points, other key locations may be used consistent with the spirit of the invention. The method of the present invention includes on-site laundry operations 30. For the purpose of this method, there are 5 key locations with check points that will record information from identification tags 2 including fixed check point 32 recording linen location 64 as “linen sorting area” and linen status 66 as “SOILED,” fixed check point 34 recording linen location 64 as “washing machines” and linen status 66 as “SOILED,” fixed check point 36 recording linen location 64 as “drying machines” and linen status 66 as “CLEAN” while updating lifecycle record 78 by increasing wash count by one, fixed check point 38 recording linen location 64 as “linen storage” and linen status 66 as “CLEAN,” and mobile check point 40 recording linen location 64 as “guest room” and linen status 66 as “CLEAN.” Time stamp records and linen status 66 will be recorded when identification tag 2 enters the read field of any given check point.

5. Outsourced Laundry Operations

FIG. 5 depicts a flow diagram of linen products throughout outsourced laundry operations 42. Due to potential read field overlap or variance in desired check points, other key locations may be used consistent with the spirit of the invention. The method of the present invention includes outsourced laundry operations 42. For the purpose of this method, there are 5 key locations with check points that will record information from identification tags 2 including fixed check point 32 recording linen location 64 as “linen sorting area” and linen status 66 as “SOILED,” fixed check point 44 recording linen location 64 as “outgoing linens” and linen status 66 as “SOILED,” fixed check point 46 recording linen location 64 as “incoming linens” and linen status 66 as “CLEAN” while updating lifecycle record 78 by increasing wash count by one, fixed check point 38 recording linen location 64 as “linen storage” and linen status 66 as “CLEAN,” and mobile check point 40 recording linen location 64 as “guest room” and linen status 66 as “CLEAN.” Time stamp records and linen status 66 will be recorded when identification tag 2 enters the read field of any given check point.

6. On-Site and Outsourced Laundry Operations

FIG. 6 depicts a flow diagram of linen products throughout on-site and outsourced laundry operations 48. Due to potential read field overlap or variance in desired check points, other key locations may be used consistent with the spirit of the invention. The method of the present invention includes on-site and outsourced laundry operations 48. For the purpose of this method, there are 7 key locations with check points that will record information from identification tags 2 including fixed check point 32 recording linen location 64 as “linen sorting area” and linen status 66 as “SOILED,” fixed check point 44 recording linen location 64 as “outgoing linens” and linen status 66 as “SOILED,” fixed check point 46 recording location 64 as “incoming linens” and linen status 66 as “CLEAN” while updating lifecycle record 78 by increasing wash count by one (for outsourced incoming linen products), fixed check point 34 recording linen location 64 as “washing machines” and linen status 66 as “CLEAN,” fixed check point 36 recording linen location 64 as “drying machines” and linen status 66 as “CLEAN” while updating lifecycle record 78 by increasing wash count by one (for linen products laundered on-site), fixed check point 38 recording linen location 64 as “linen storage” and linen status 66 as “CLEAN,” and mobile check point 40 recording linen location 64 as “guest room” and linen status 66 as “CLEAN.” Time stamp records and linen status 66 will be recorded when identification tag 2 enters the reader zone of any given check point.

7. Hotel Exit Locations

FIG. 7 depicts a block diagram of check points at exit locations 50. Due to potential read field overlap or variance in desired check points, other key locations may be used consistent with the spirit of the invention. The method of the present invention includes exit check points 50. For the purpose of this method, there are 5 key locations with check points that will record information from identification tags 2 including fixed check point 52 recording linen location 64 as “staff exit” and linen status 66 as “OFFSITE,” fixed check point 54 recording linen location 64 as “front exit” and status 66 as “OFFSITE,” fixed check point 56 recording linen location 64 as “rear exit” and linen status 66 as “OFFSITE,” fixed check point 58 recording linen location 64 as “side exit #1” and linen status 66 as “OFF SITE,” and fixed check point 60 recording linen location 64 as “side exit #2” and linen status 66 as “OFFSITE.” Time stamp records and linen status 66 will be recorded when identification tag 2 enters the read field of any given check point. Any records generated at these check points will require a notification 62 to generate and send to management, further detailed in the “Notifications” section.

8. Delivery

FIG. 8 illustrates the delivery decision tree that will be used when linen products are delivered to rooms according to the present invention. When an employee delivers linen products to rooms and uses the RFID Handheld Reader 14 to record delivery either on the way to delivery or at the guest room, the RFID Handheld Reader 14 may be preprogrammed to prompt certain questions to aid in generating records. The RFID Handheld Reader 14 will prompt the user to enter room number and will then ask user if the items delivered were part of a requested linen product delivery. If the employee is delivering linen products as part of a room cleaning, they will answer “NO” and then the read field will activate to read linen products. The system will ask the user if they wish to complete the record. If the user answers “YES,” the read field will deactivate, and records will be generated, and if they answer “NO,” the read will continue until user selects “YES” to complete the record. If additional linen products were requested for that room, the user will answer “YES.” Within the system, the sequential rule will be excluded, and the read field will be activated to read linen products. The system will ask the user if they wish to complete the record. If the user answers “YES,” the read field will deactivate, and records will be generated, and if they answer “NO,” the read will continue until user selects “YES” to complete the record. For requested linen product delivery, quantity of items associated with the given room number will increase. Additional or other delivery decision tree steps may be used consistent with the spirit of the present invention.

The sequential rule mentioned above is intended to ensure accurate records are generated. If linen products are not changed in a guest room when they should have been, and an employee uses RFID Handheld Reader 14 to create false records and try to indicate items are clean, the sequential rule detects this. If the aforementioned situation occurs and the linen products' identification tags are recorded at the guest room check point 40, sequential timestamps at the same check point will be generated within the tracking database 22 and linen products will automatically have linen status 66 change to “SOILED” due to the sequential precords. The conditions to obtain a linen status 66 of “CLEAN” and how that relates to this sequential rule are further detailed in the “Status” section.

Additionally, if the tracking database 22, data management database 24, or the additional software 26 detects that the entered room number had deliveries recorded more than usual, for example, three times in one day, the system will prompt the user if they entered the correct room number and will additionally send a notification 62 of abnormal delivery to management, further detailed in the “Notifications” section. This abnormal delivery scenario may occur when employees are not abiding by protocol or are entering inaccurate room numbers.

Delivery methods may change with evolving RFID technology, however any method coinciding with status generation based a decision tree considering records including those generated from the tracking database 22, the data management database 24, and additional software 26 are consistent with the spirit of the present invention.

9. Reader Databases and Records

FIG. 9 depicts a flow diagram of information recorded when an identification tag 2 is registered by a fixed and mobile check point. As identification tag 2 is registered in the read field at a fixed check point by the RFID Antenna 8, the RFID Fixed Reader 12 will have (preinstalled) databases: tracking database 22, data management database 24, and additional software 26. For a mobile check point, the RFID Handheld Reader 14 will also have the tracking database 22, data management database 24, and additional software 26. Both fixed and mobile check points will register identification tag 2 when it is recognized in the read field. The tracking database 22 will generate information including but not limited to: notifications 62, linen location 64, linen status 66, time stamp 68, work-in-process tracking 70, and inventory control 72. The data management database 24 will generate information including but not limited to: RFID tag commissioning 80, RFID file management 82, birth record 74, current data record 76, and lifecycle record 78. Additional software 26 may generate any additional records. Varying types of records may be used consistent with the present invention. Any of the aforementioned databases have the capabilities to generate custom records in accordance with the tracking goals of any such hotel and may be used consistent with the present invention. Database information will be sent to the Cloud 28 and will contribute to generating the on-site laundry operations record 30, outsourced laundry operations record 42, or on-site and outsourced laundry operations record 48, relative to which type of laundry operations that hotel utilizes.

10. Status

FIGS. 10a-10d depict decision trees for using data records to generate linen status 66 for linen products. Linen status 66 information presented to guests or management will require some conditions within the software such as the tracking database 22, data management database 24, or additional software 26. Depicted in FIG. 10a, linen status 66 is “SOILED” if there are sequential records at any identical check point, so as to prevent intentional or unintentional, inaccurate linen status 66 change. This will apply for a 7-day time frame, or any other specific timeframe preferred consistent with the spirit of the invention. If there are not sequential records, system will move to FIG. 10b if the location utilizes on-site laundry operations 30, to FIG. 10c if outsourced laundry operations 42 are utilized, or to FIG. 10d if on-site and outsourced laundry operations 48 are utilized.

Depicted in FIG. 10b, linen products in guest rooms from on-site laundry operations 30 have a linen status 66 of “CLEAN” if read at all check points 32, 34, 36, 38, and 40, which have linen locations 64 of the linen sorting area, washing machines, drying machines, linen storage, and guest room, respectively. Check points may vary upon location, thus one identification tag 2 read at each respective check point qualifies the linen product in a guest room 40 as “CLEAN” consistent with the spirit of the invention. If a linen product is read at the check point 32, linen status 66 is “SOILED,” and if it is not read at this check point, it remains “CLEAN” according to previous check point 40. If a linen product is read at check point 34, linen status 66 is “SOILED,” and if it is not yet read at this check point, it remains “SOILED” according to previous check point 32. If a linen product is read at check point 36, linen status 66 is “CLEAN,” and if it is not yet read at this check point, it remains “SOILED” according to previous check point 34. If a linen product is read at check point 38, linen status 66 is “CLEAN,” and if it is not yet read at this check point, it remains “CLEAN” according to previous check point 36. If a linen product is read at check point 40, linen status 66 is “CLEAN,” and if it is not yet read at this check point, it remains “CLEAN” according to previous check point 38.

Depicted in FIG. 10c, linen products in guest rooms from outsourced laundry operations 42 have a linen status 66 of “CLEAN” if read at all check points 32, 44, 46, 38, and 40, which have linen locations 64 of the linen sorting area, outgoing linens, incoming linens, linen storage, and guest room, respectively. Check points may vary upon location, thus one read at each respective check point may be used to qualify a linen product in a guest room 40 as “CLEAN” consistent with the spirit of the invention. If a linen product is read at check point 32, linen status 66 is “SOILED,” and if it is not read at this check point, it remains “CLEAN” according to previous check point 40. If a linen product is read at check point 44, linen status 66 is “SOILED,” and if it is not yet read at this check point, it remains “SOILED” according to previous check point 32. If a linen product is read at check point 46, linen status 66 is “CLEAN,” and if it is not yet read at this check point, it remains “SOILED” according to previous check point 44. If a linen product is read at check point 38, linen status 66 is “CLEAN,” and if it is not yet read at this check point, it remains “CLEAN” according to previous check point 46. If a linen product is read at check point 40, linen status 66 is “CLEAN,” and if it is not yet read at this check point, it remains “CLEAN” according to previous check point 38.

Depicted in FIG. 10d, linen products in guest rooms from on-site and outsourced laundry operations 48 have a linen status 66 of “CLEAN” if read at all check points 32, 44, 46, 34, 36, 38, and 40, which have linen locations 64 of the linen sorting area, outgoing linens, incoming linens, washing machines, drying machines, linen storage, and guest room, respectively. Check points may vary upon locations, thus one read at each respective check point may be used to qualify a linen product in a guest room 40 as “CLEAN” consistent with the spirit of the invention. If a linen product is read at check point 32, linen status 66 is “SOILED,” and if it is not read at this check point, it remains “CLEAN” according to previous check point 40. If an outsourced linen product is read at check point 44, linen status 66 is “SOILED,” and if it is not read at this check point, it remains “SOILED” according to previous check point 32. If an outsourced linen product is read at check point 46, linen status 66 is “CLEAN,” and if it is not read at this check point, it remains “SOILED” according to previous check point 44. If an on-site linen product is read at check point 34, linen status 66 is “SOILED,” and if it is not read at this check point, it remains “SOILED” according to previous check point 32. If an on-site linen product is read at check point 36, linen status 66 is “CLEAN,” and if it is not read at this check point, it remains “SOILED” according to previous check point 34. For any linen product read at check point 38, linen status 66 is “CLEAN,” and if it is not read at this check point, it remains clean according to previous check point 36 from on-site laundry or check point 46 from outsourced laundry. If a linen product is read at check point 40, linen status 66 is “CLEAN,” and if it is not yet read at this check point, it remains “CLEAN” according to previous check point 38.

Details on obtaining a linen status 66 of “SOILED” when sequential records are detected have been described in the previous “Delivery” section. Simply put, sequential time stamps 68 at the same check point will be generated within the tracking database 22 and linen products will automatically have linen status 66 change to “SOILED” due to the sequential records. Moreover, to obtain a linen status 66 of “SOILED” there may be zero sequential recorded scans of identification tag 2 at any given check point within laundry operations during a 7-day time frame (or any other specific timeframe preferred consistent with the spirit of the invention), and if the guest requests additional linen products there will be a spot on the RFID Handheld Reader 14 to indicate requested linen product delivery. Any other identification tags 2 detected which are not within the specified read will not automatically change to “SOILED” because the sequential recorded scans are associated with requested linen product delivery time.

Additionally, linen status 66 may be changed to “TERMINATED” within the data management database 22 with a reason for termination. Additional terms for generating linen status 66 may be used consistent with the spirit of the invention.

Correspondingly, information may be presented to guests via mobile application, website, or any other web interface by queuing information from the cloud 28. Information on the cloud 28 is intended to generate reports, comprising information the location wishes to make public for guests, such as linen status 66 regarding cleanliness of linen products in each hotel room or statistics on overall laundry operations.

11. Notifications

Within the tracking database 22 there will be the option to generate and send notifications 62 to management via email and popup notification on computer. Notifications 62 may be sent in various situations as set within tracking database 22, data management database 24, and additional software 26.

When an identification tag 2 has a linen status 66 that changes to “OFF SITE,” a notification 62 will be sent including information on the identification tag 2 such as linen category, tracking record, last recorded checkpoint, along with others.

When an identification tag 2 has a linen status 66 changes to “TERMINATED,” a notification 62 will be sent including information on the identification tag 2 such as linen category, tracking record, lifecycle record 78, reason for termination, and so on.

In the situation of abnormal delivery, that is when linen products in a guest room have been changed three times in one day, the tracking control will prompt the user if they entered the correct room number and will additionally send a notification 62 of abnormal delivery to management. This may highlight a housekeeping problem such that employees are not following protocol or are entering inaccurate room numbers.

Since each linen product has its own lifecycle preset in the data management database 24, a notification 62 will be sent when the lifecycle 78 thereof is ended when the wash count has reached the predetermined limit.

Notifications 62 may be sent when identification tags 2 are inactive for a predetermined time period, for example 30 days, including information on the identification tags 2 such as identification number, linen category, tracking record, last recorded linen location 64, and so on. Then, a RFID Handheld Reader 14 may be used to locate identification tag 2 by inputting identification number of the identification tag 2 and using the location detection feature. Correspondingly, this may identify any problems with the present laundry operations system.

Another notification 62 that may be sent is a detailed statistical report on laundry operations sent daily, weekly, monthly, quarterly, and/or annually, adjustable according to company standard.

Users may require other notifications 62 for any additional records generated consistent with the spirit of the invention.

12. Lifecycle

Lifecycle 78 for each category of linen product may be preset within the data management database 24. This preset lifecycle 78 may be a goal or a prediction based on the normal wear and tear including factors such as bed making and stripping procedures, condition of chutes, transport and rates of end user abuse at that location. As a linen product is terminated, average lifecycle 78 for category of said item will update. This aspect of the present invention may prove useful for management to compare average lifecycles and the preset lifecycles so as to improve linen utilization. Continuing, a notification 62 will be sent when the lifecycle 78 of identification tag 2 is ended, as detailed in “Notification” section. Correspondingly, the data management database 24 should increase quantity of wash count by one within lifecycle 78 when linen product is recognized by one preset check point within laundry operations, for example check point 36 for on-site laundry operations 30 or check point 46 for outsourced laundry operations 42. For example, a pillowcase is set in the data management database 24 to have 70 cycles throughout laundry operations. Once the pillowcase is recognized by check point 36 or check point 46 70 times, a notification 62 will be generated for discarding the pillowcase. Any one check point in laundry operations may be used to increase quantity of wash count consistent with the spirit of the invention.

13. Linen Product Identification

RFID Handheld Reader 14 may be used to recognize unique identification number of identification tag 2. Using the identification feature in the RFID Handheld Reader 14, the user has the ability to scan a linen product so as to retrieve the identification number to search information in the tracking database 22, data management database 24, or additional software 26. Function may prove useful when reviewing information such as linen status 66, time stamp 68, birth record 74, current data record 76, and lifecycle record 78.

If a notification 62 was generated and sent regarding an inactive identification tag 2, the RFID Handheld Reader 14 may be used to locate the linen product wherein the reader field is activated to scan for an identification number matching the one belonging to the identification tag 2 in question.

If there is any question on linen status 66 regarding cleanliness of a linen product, the RFID Handheld Reader 14 may be used to recognize and pull information on the linen product's identification tag 2 and related records.

There are many other circumstances where linen product identification may prove useful consistent with the spirit of the invention.

14. Alternatives and Variations to the Preferred Embodiment

A variation to the preferred embodiment of the present invention includes using active RFID tracking technology, indoor GPS, or any other form of technology wherein an identification tag 2 may have an exact pinpointable linen location 64 so as to track the linen product's exact positioning in guest rooms and between key locations throughout laundry operations.

Another variation to the preferred embodiment of the present invention includes using all fixed check points, all mobile check points, or a different combination of the two so as to achieve cleanliness linen status 66 and linen location 64.

An alternative to the preferred embodiment of the present invention includes utilizing only one check point if there is only one hallway leading to the loading dock and receiving docks. Current RFID technology has the ability to recognize out-bound and in-bound movements, so the tracking control may be programmed to record the out-bound movement as recorded at check point 44 (outgoing linens), and the in-bound movement as recorded at check point 46 (incoming linens). This alternative applies to outsourced laundry operations 42 and on-site and outsourced laundry operations 48.

Another variation to the preferred embodiment of the present invention includes utilizing fixed check points in every guest room rather than using a mobile check point—RFID Handheld Reader 14—stored on a housekeeping cart. Similar to this is using fixed check points on the housekeeping carts so as to record linen products as the employee services a guest room. Both aspects of this variation could become a rather costly solution considering the high quantity of guest rooms and equipment needed for each, however it still achieves tracking in accordance with the present invention.

An alternative to the preferred embodiment of the present invention includes installing identification tags 2 on kitchen linens so as to provide accurate inventories. Hotels may struggle anticipating clean kitchen linens or simply just getting a current, accurate inventory of their stock. Check points may be set up to track the kitchen linens throughout laundry operations and exit locations, with certain check points recording linen status 66 as “CLEAN” or “SOILED.” This utilizes the method of tracking linen throughout laundry operations and exit locations while including a type of hotel linen that benefits from tracking.

Another variation to the preferred embodiment of the present invention includes utilizing RFID identification tags 2 that sense moisture and/or high temperatures so as to verify that the linen product went through the harsh conditions of washing and/or drying. Currently known as passive UHF RFID moisture sensing tags or passive UHF RFID temperature sensing tags, the tags may be implemented in the same manner consistent with the present invention with additional data collection at certain check points relating to the specifications of the sensor within the identification tag 2. In on-site laundry operations 30, check point 34 will record information on whether moisture was sensed by identification tag 2, which in this case specializes in moisture sensing. If a temperature sensing tag was used, check point 36 will record temperature-related information sensed by identification tag 2. In outsourced laundry operations 42, information may be collected at the receiving dock check point 46 from the identification tag 2 relating to moisture and/or temperature the linen product experienced while away. In on-site and outsourced laundry operations 48, check point 34 will record information on whether moisture was sensed by identification tag 2, which in this case specializes in moisture sensing. If a temperature sensing tag was used, check point 36 will record temperature-related information sensed by identification tag 2. Check point 46 will record information from identification tag 2 relating to the moisture and/or temperature the linen product experienced while away. Moisture and temperature sensor RFID tags are relevant to the spirit of the present invention in that they help assure the linen product in question went through specific environmental factors such as water and high temperatures to be assigned a linen status 66 of “CLEAN.” This technology takes linen tracking a step further to assure the safety and experience of hotel guests.

An alternative to the preferred embodiment of the present invention includes changing the route records generated within the readers takes to get to the tracking control. This means changing the Wi-Fi internet connection to an intranet connection, or using an extranet connection, which is a blend of internet and intranet. Intranet is a great variation in that it secures the network so as to prevent access by outside sources. Extranet is a great variation in that it utilizes the security of a private intranet and is connected to the internet to allow access by predetermined groups of people.

Another variation to the preferred embodiment of the present invention includes providing users the option to determine the type of cloud service they would like to utilize when storing information from the linen tracking system. There are many Cloud services offered, allowing users to select which service best fits their cloud computing needs, such as IaaS (Infrastructure-as-a-Service), PaaS (Platform-as-a-Service), SaaS (Software-as-a-Service) or Storage, Database, Information, Process, Application, Integration, Security, Management, or Testing-as-a-Service. So long as a computing and storage platform is utilized for information generated within the present invention, choice in primary cloud services are consistent with the spirit of the invention.

15. Conclusion

As to a further discussion of the manner of usage and operation of the present invention, the same should be apparent from the above description. Accordingly, no further discussion relating to the manner of usage and operation will be provided.

With respect to the above description then, it is to be realized that the optimum relationships for the parts of the invention, to include variations in materials, form, function and manner of operation, assembly, and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A method of tracking hotel linen products, comprising the steps of:
a. permanently installing identification tags onto a plurality of linen products;
b. wirelessly linking said identification tags with a tracking control, wherein each of said identification tags contains a unique identification number preset by said tracking control;
c. installing a plurality of check points at various key locations respectively to link with said tracking control, wherein said identification tag corresponding to said linen product is registered when entering the read field of said check point;
d. generating a tracking record within said tracking control for said linen products thereby monitoring said linen products in near real time as they move to each of said check points;
e. generating a status record within said tracking control for said linen products reflecting said check points in which said linen products were recorded;
f. generating a location record within said tracking control for said linen products reflecting said check points in which said linen products were recorded;
g. generating a lifecycle record within said tracking control for said linen products characterized by said predetermined checkpoints in which lifecycle was updated;
h. updating status record within said tracking control for said linen products in accordance to said check points where said linen products were recorded;
i. notifying hotel management that said linen product's status has changed to “terminated” in response to end of said lifecycle or “offsite” in response to said linen product exiting offsite said hotel via exit locations; and
j. synchronizing the tracking control with a Cloud-based system wherein a plurality of said records are accessible to users with Internet connection.

2. The method of claim 1 wherein step (a) comprises of the sub-steps of:
(a-1) attaching said identification tags onto said linen products so that said identification tags cannot be removed from normal washing processes; and
(a-2) attaching said identification tags onto a bottom corner of said linen products so as to not infringe on a hotel guest's ease of use.

3. The method of claim 1 wherein step (b) comprises the sub-steps of:
(b-1) using a device to read said identification tag which is affixed on said linen product;
(b-2) assigning said identification number to said identification tag;
(b-3) classifying said linen products into a plurality of linen categories, in which bed linens include “sheets,” “pillowcases,” “mattress covers,” “blankets,” and other types of said linen products, while bath linens include “bath towels,” “wash cloths,” “hand towels,” “bath mats,” and other types of said linen products, in addition to any other said linen categories;
(b-4) assigning said identification numbers of said identification tags into each of said linen categories; wherein when each of said linen products is read at said check point, said tracking control identifies said linen product, records location for tracking records, and generates other relative records such as status and lifecycle;
(b-5) instructing said tracking control to generate inventories and records for said linen categories; and
(b-6) instructing said tracking control to generate inventories of said linen products for each of said linen statuses such as “clean,” “soiled,” “offsite,” or “terminated.”

4. The method of claim 1 wherein step (c) comprises of the sub-steps of:
(c-1) evaluating said hotel's said laundry operations process and said exit locations to determine said key locations for said check points;
(c-2) installing said check points characterized by a fixed reader connected via cable to an antenna;
(c-3) creating mobile read fields by using a mobile handheld reader for said check point;
(c-4) connecting said fixed reader and handheld reader to the internet; and
(c-5) installing tracking software including a tracking database, a data management database, and any additional software to said fixed readers and said handheld readers so as to create said tracking control.

5. The method of claim 1 wherein step (d) comprises the sub-steps of:
(d-1) recording each of said hotel linen products in said tracking control when said identification tag is registered with said check point;
(d-2) recording time in said tracking control when said identification tag is registered with said check point; and
(d-3) generating said tracking record in response to said linen product's history.

6. The method of claim 1 wherein the step (e) comprises the sub-steps of:
(e-1) classifying said check points into a plurality of status categories in respect to being said “clean” status, said “soiled” status, or said “offsite” status;
(e-2) assigning said status for said identification tags entering said read fields of said check points;
(e-3) instructing said tracking control to provide said status in response to said tracking record including said records at each of said check points; and
(e-4) allowing said hotel management to use said tracking control to change said status to “terminated” in response to said linen product reaching end of lifecycle.

7. The method of claim 1 wherein the step (f) comprises the sub-steps of:
(f-1) classifying said check points into a plurality of location categories in respect to said key locations in said hotel's said laundry operations process;
(f-2) instructing said tracking control to record said location for said identification tags entering said read fields of said check points; and
(f-3) instructing said tracking control to provide said location on demand for said tracking record including said records at each of said check points.

8. The method of claim 1 wherein the step (g) comprises the sub-steps of:
(g-1) predetermining one check point—for example, washing machines—within said laundry operations process that will add one number to the wash count when said identification tag enters said read field of said check point so as to update said lifecycle of said linen product;
(g-2) recording said wash count for said identification tags entering said read fields of said check points;
(g-3) instructing said tracking control to provide said lifecycle record in response to said tracking record including said records at each of said check points; and
(g-4) instructing said tracking control to notify hotel management when said hotel linen product has reached the predetermined wash count whereby lifecycle has ended, so as to enhance quality control of said linen products.

9. The method of claim 1, wherein step (h) further comprises instructing said tracking control to update said identification tag's said status when registered at said check points and when instructed to terminate said linen product.

10. The method of claim 1 wherein step (i) further comprises the sub-steps of:
(i-1) entering specific email addresses of said management into said tracking control's databases for the delivery of said notifications;
(i-2) instructing said tracking control to generate said notification to send to said email addresses when said identification tag's status changes to said “terminated” status in response to said hotel management manually terminating said linen product at end of said lifecycle;
(i-3) instructing said tracking control to generate said notification to send to said email addresses when said identification tag's status changes to “offsite” in response to registering with said check point's read field; and
(i-4) instructing said tracking control to include data in said notification including said identification tag number, said linen category of said identification tag, and said check point read at.

11. The method of claim 1 wherein step (j) comprises connecting said fixed reader and said handheld reader to the Internet at said hotel and instructing said tracking control to update said cloud-based system as new records are generated so as to achieve near real time updates.

12. The method of claim 1 wherein each of said identification tags are RFID tags comprising a microchip that wirelessly registers in a radio wave manner with each of said check points, which is encased therein by a protection sleeve made of waterproof and heat resistant material, wherein said microchip is sealed by said protection sleeve attached to each of said linen products.

13. The method of claim 1 wherein said check points are set at said key locations in respect to said hotel's laundry operations process being on-site, outsourced, or on-site and outsourced, in addition to setting said check points at said hotel exits.

14. The method of claim 13 wherein said on-site laundry operations process comprises said check points located at said linen sorting area, said washing machines, said drying machines, said linen storage, and said guest rooms.

15. The method of claim 13 wherein said outsourced laundry operations process comprises said check points located at said linen sorting area, said outgoing linens, said incoming linens, said linen storage, and said guest rooms.

16. The method of claim 13 wherein said on-site and outsourced laundry operations process comprises said check points located at said linen sorting areas, said outgoing linens, said washing machines, said drying machines, said incoming linens, said linen storage, and said guest rooms.

17. The method of claim 13 wherein said hotel exits comprises check points at the front exit, rear exit, staff exit, side exit #1, and side exit #2.

18. The method of claim 1 wherein said tracking control comprises a tracking database and a data management database storing information including said tracking record to track linen throughout said hotel, said status record, said location record, said lifecycle record, said time record, said notifications, said linen categories, and any other records relative to tracking linen so as to achieve optimal quality control for said hotel guests.
